(19) United States
(12) Patent Application Publication
(10) Pub. No.: US 2008/0190037 A1
(43) Pub. Date: Aug. 14, 2008

(54) METHOD OF PREPARING AGGLOMERATED COMPOSITE MATERIALS

(76) Inventors: David P. Workman, Naperville, IL (US); Michael A. Romba, Joliet, IL (US); Ronald S. Doles, LaGrange Park, IL (US)

Correspondence Address: NALCO COMPANY, 1601 W. DIEHL ROAD, NAPERVILLE, IL, 60563-1198, US

(21) Appl. No.: 12/105,732

(22) Filed: Apr. 18, 2008

Related U.S. Application Data
(63) Continuation of application No. 10/880,910, filed on Jun. 30, 2004, now abandoned.
Application No. 10/880,910 is a continuation-in-part of application No. 10/610,687, filed on Jul. 1, 2003, now abandoned.

(51) Int. Cl. B01J 2/28; B24D 3/02; C04B 14/04; B32B 9/00

(52) U.S. Cl. 51/309; 23/313 R; 106/401; 106/485; 502/439; 428/32.34

(57) ABSTRACT

Metal oxide particle agglomerates prepared by adding an aluminum phosphate agglomerating agent with mixing to an aqueous dispersion of metal oxide nanoparticles to form an aqueous homogeneous dispersion of nanoparticles and agglomerating agent and then adjusting the pH of the dispersion with mixing to about 3.5 to about 6.5 to produce the particle agglomerates and use of the particle agglomerates to prepare ink receptive coatings, as catalysts, as reinforcing fillers, as polishing abrasives and as flattening agents.

### CROSS REFERENCE TO RELATED APPLICATIONS

This is a continuation of Ser. No. 10/880,910, filed Jun. 30, 2004; which is a continuation in part of Ser. No. 10/610,687, filed Jul. 1, 2003, now abandoned.

### TECHNICAL FIELD

This invention is a method of preparing particle agglomerates having a controlled particle size and porosity and use of the agglomerated particle agglomerates, particularly in ink receptive coatings, as catalysts, as polishing abrasives, as reinforcing fillers and as flattening agents.

### BACKGROUND OF THE INVENTION

Metal oxides such as silica in their various forms are useful in multitudinous applications including, for example, as catalyst supports, as retention and drainage aids in papermaking, in surface coatings, as flattening agents, as proppants and as polishing abrasives, particularly in the electronics industry. The form of metal oxide used in a particular application depends in large part on the silica particles size and porosity characteristics.

For example, common forms of silica include colloidal silica, precipitated silica, silica aerogels and fumed silica. Colloidal silica consists of a suspension of usually discrete particles in a solvent with particle size ranging from 3 nm to 150 nm and little or no porosity. Precipitated silicas are dried particles with size ranging between 1 and 20 μm and surface area between 25 and 700 m²/g. Silica aerogels are dried particles with particle size from several microns to millimeters and surface area up to 800 m²/g. Fumed silica is an extremely small particle with surface area ranging from 100 to 400 m²/g with a tendency to form chains in the chemical manufacturing process.

In catalysis, silica is used as a catalytic support, or as a porous layer coated or impregnated on monolithic supports. Colloidal silica is used in the production of catalytic supports because of its excellent binding properties. It may be used separately or in conjunction with other materials such as but not limited to clays, alumina, silica gel and fumed silica.

Silica is used in paper as a retention and drainage aid and in coatings such as anti-skid, anti-block and ink receptive. In ink receptive coatings the coating pigment has specific porosity characteristics that are required in order to facilitate ink absorption. Colloidal silica is used as a retention and drainage aid and in anti-skid and anti-block applications. Silica gel and fumed silica are commonly used in numerous coating applications including ink receptive.

As filler, through surface interactions, silica reinforcement increases the strength and wear resistance of various materials including rubber and plastics, allowing them to be used in a wider number of applications in accordance with the user's exact requirements. Precipitated silica and fumed silica are used as fillers for this application.

As flattening agent, where inclusion of particles of sufficient size (greater than 300 nm) in coating formulation can result in increased roughness of finished coating. The increased roughness results in increased scattering of light and a reduction in the specular gloss of the surface. Fumed silica and precipitated silica are used a flattening agents in applications such as paints or automotive coatings.

Thus, for these and numerous other applications, it is necessary for the silica to have certain morphological characteristics, including particle size and porosity. Accordingly, there is an ongoing need for methods of selectively preparing silica particles having the desired agglomerate particle size and porosity in order to maximize performance of the silica particles in the desired application.

Silica/alumina composite particles prepared by mixing a silica sol and an acidic aluminum salt in an aqueous medium and a coating for an ink jet printing medium comprising the particles is disclosed in U.S. patent application no. 2002/0171730 A1.

### SUMMARY OF THE INVENTION

This invention is a method of preparing a metal oxide particle agglomerate comprising

a) adding an aluminum phosphate agglomerating agent with mixing to an aqueous dispersion of one or more metal oxide nanoparticles to form an aqueous homogeneous dispersion of nanoparticles and agglomerating agent; and
b) adjusting the pH of the dispersion with mixing to about 3.5 to about 6.5 to agglomerate the nanoparticles.

The method of this invention permits preparation of particle agglomerates having controlled size and porosity.

The particle agglomerate prepared as described herein is capable of forming a coating film or particle with controlled size and porosity which is suitable for applications including coatings for recording media such as ink receptive coatings for paper, as polishing abrasives, as catalysis supports, as fillers, as retention and drainage aids in papermaking and as flattening agents.

### DETAILED DESCRIPTION OF THE INVENTION

The production of particle agglomerates according to this invention is a two step process involving adding an agglomerating agent to an aqueous dispersion of one or more metal oxide nanoparticles and then inducing the agglomeration of the particles by adjusting the pH of the dispersion to about 3.5 to about 6.5. Control of the agglomerate particle size is accomplished through control of primary nanoparticle size, nanoparticle concentration, agglomerating agent concentration, and the method of pH adjustment as described herein.

The particle agglomerates of this invention are clusters of nanoparticles that result from the controlled coagulation of the starting nanoparticles under the conditions described herein. The size of typical particle agglomerates can range up to about 10 to about 20 microns. Preferred particle agglomerates have a particle size of less than about two microns.

Nanoparticles suitable for preparing the particle agglomerates of this invention are selected from metal oxides having a typical particle size less than about 500 nm, preferably less than about 300 nm. The surface area of the nanoparticles is typically less than about 400 m²/g, preferably less than about 300 m²/g.

The metal oxides may be cationic, anionic or neutral. Representative metal oxide nanoparticles include silica sols, fumed silica, aluminum oxides, filmed alumina, iron oxides, zinc oxide, zirconium oxides, tin oxides, cerium oxides, and the like. “Metal oxides” as used herein is also intended to encompass hydrated metal oxides as described below. The nanoparticles may also be coated with one or more metal oxides. Examples of coated nanoparticles include aluminum oxide coated silica, cerium oxide coated silica, and the like.

The nanoparticles can be amorphous in nature or have a variety of shapes including spheres, platelets, rods, cubes, and the like, and mixtures thereof. The morphology of the particle agglomerate derives from particle shape(s) of the nanoparticle.

The metal oxide nanoparticles described herein are well-known and commercially available in a range of particle sizes and morphologies as aqueous dispersions and/or as dry powders. Dry powders should be dispersed in water prior to use in the method of this invention.

As used herein, “silica sol” means a stable dispersion of alkaline or deionized colloidal silica particles in water. Typical particle sizes range from about 3 to about 120 nm. Silica sols are commercially available, for example from Nalco Company, Naperville, Ill.

The production of deionized silica sols is known in the art. The deionized silica particles used to prepare the agglomerated silica in the process of this invention are prepared by deionizing an alkaline silica sol using strong acid cation and strong base anion resins such as those available from Dow Chemical Company, Midland, Mich. under the tradenames, Dowex 650C Dowex 550A.

“Fumed silica” means silicon dioxide particles prepared by the vapor phase hydrolysis of silicon tetrachloride, typically having a particle size of less than about 50 microns. Fumed silica is commercially available, for example from Cabot Corporation, Boston, Mass. under the tradename CAB-O-SIL.

“Aluminum oxide” means particles of formula Al₂O₃ and hydrated oxides thereof. Common aluminum oxides include α—Al₂O₃ (“corundum”) and γ—Al₂O₃. Hydrated oxides include compounds of formula Al(O)OH (“boehmite”) and Al(OH)₃ (“gibbsite”). Boehmites having suitable particle sizes are available, for example, from Sasol North America Inc., Houston, Tex. under the tradenames DISPERAL and DISPAL. Fumed alumina having suitable particle sizes is available, for example, from Cabot Corporation, Boston, Mass.

“Iron oxide” means particles of formula Fe₂O₃ (“hematite”) and Fe₃O₄ (“magnetite”) and hydrated oxides thereof. Hydrated iron oxide can exist in various forms depending on its method of preparation. For example, hydrous ferric oxide (FeO(OH)) is prepared by oxidation of iron (II) hydroxide. Hydrous ferric oxide and another form of FeO(OH), lepidrocrocite, can be dehydrated to form α-Fe₂O₃ and β-Fe₂O₃, respectively.

“Zinc oxide” means particles of formula ZnO.

“Zirconium oxide” means particles of formula ZrO₂. Hydrated zirconium oxides, ZrO₂.nH₂O, can be precipitated from Zr(IV) solutions by addition of hydroxide.

“Tin oxide” means particles of formula SnO₂. Hydrated tin(IV) oxides include the α and β stannic acids (SnO₂.nH₂O).

“Cerium oxide” means particles of formula CeO₂.

According to the method of this invention, an aluminum phosphate agglomerating agent is added to the dispersion of nanoparticles with mixing in an amount of about 2 to about 25 weight percent, based on dry weight of silica and agglomerating agent and the pH of the dispersion is then adjusted to about 3.5 to about 6.5, preferably about 4 to about 6 with aqueous base in order to agglomerate the nanoparticles. Suitable bases for the pH adjustment include hydroxides such as NaOH and KOH and amines and ammonium hydroxides of formula NR₄OH where R is H or C₁-C₄ alkyl or a mixture thereof. NaOH, KOH and NH₄OH are preferred.

Alternatively, the pH is adjusted by mixing the dispersion of nanoparticles and agglomerating agent with an aqueous pH aqueous buffer solution. For example, a dispersion of silica particles and agglomerating agent can be poured into an acetic acid/acetate buffer solution resulting in a final pH of 4.0-5.5.

In a preferred aspect of this invention, the metal oxide nanoparticles are selected from the group consisting of coated and uncoated colloidal silica.

In another preferred embodiment, the coated colloidal silica is selected from the group consisting of aluminum oxide coated silica and cerium oxide coated silica.

In another preferred embodiment, the colloidal silica particles have a particle size of about 3 nm to about 150 nm as measured by quasi elastic light scattering.

The aqueous dispersion of agglomerated particles may then be concentrated to the desired concentration using, for example, ultrafiltration, evaporation, and centrifugation techniques.

As discussed above, the process of this invention is used to prepare agglomerated particles having a controlled particle size and/or porosity.

The variables that have the largest impact on particle size are the primary particle size, nanoparticle concentration and aluminum phosphate agglomerating agent dosage. The method of pH adjustment indirectly impacts particle size by modifying the operational limits of nanoparticle concentration and agglomerating agent dosage. The concentration of nanoparticle ranges from about 2 percent to about 25 percent with satisfactory results depending upon the method of pH adjustment. Using NaOH or other alkali agent requires nanoparticle concentration in 2-8 percent range, while the buffer system will support higher nanoparticle concentrations.

In general, nanoparticle concentration can be reduced without detrimental effects. The particle size (d₅₀) of the agglomerated material may rapidly grow into the micron sized if the nanoparticle concentration is outside recommended values.

The amount of aluminum phosphate agglomerating agent added is based on the dry weight of nanoparticle and agglomerating agent. Dosage at 10 percent based on solids means if nanoparticle dry weight is 1 g then the dry weight of agglomerating agent is 0.1 g. The typical agglomerating agent dose is about 5 to about 25 percent based on solids. At the high end of the range particle size starts to grow dramatically into the micron range. Dosages lower than about 2 percent result in incomplete reaction and a distribution having a small amount of agglomerated material and mostly unreacted starting sol. Reactions using a buffer system pH adjustment allow higher agglomerating agent dosages. Use of NaOH, limits the agglomerating agent dosage to about 2 percent to about 12 percent based on the nanoparticle dry weight.

Operation outside recommended ranges for nanoparticle concentration or aluminum phosphate agglomerating agent dosage result in the production of micron sized agglomerated material. The primary particle size has a direct impact on the agglomerated particle size. A primary particle at 150 nm will yield a larger agglomerate than a 60 nm primary particle.

In a preferred aspect of this invention, the particle agglomerate has a median, d50(V), particle size of about 150 nm to about 900 nm as measured by laser light scattering.

The aluminum phosphate agglomerating agent for use in the process of this invention is the reaction product of aluminum hydroxide and hot phosphoric acid resulting in a covalently bonded composition that is soluble in phosphoric acid. The aluminum phosphate agglomerating agent generates an insoluble or slightly soluble metal hydroxide or metal phosphate species during the pH adjustment step described herein.

The aluminum phosphate agglomerating agent is preferably synthesized by heating a mixture of aluminum hydroxide, [Al(OH)₃] and with about 2.5 to about 6.0 molar equivalents of phosphoric acid at a temperature of about 50 to about 100° C., preferably about 90° C., for a sufficient amount of time for substantially all of the aluminum hydroxide to react, typically about 0.5 to about 4.0 hours. About 0.1 to about 0.5 molar equivalents of boric acid is added as a stabilizer. After the reaction is complete the aluminum phosphate reagent is diluted to the desired concentration, typically about 30 to about 70 percent based on the weight of aluminum phosphate solids.

In another aspect, this invention is a method of preparing a particle agglomerate comprising

a) adding an aluminum phosphate agglomerating agent with mixing to an aqueous dispersion of a mixture of nanoparticles, the mixture comprising about 99.5 to about 50 weight percent of a first nanoparticle and about 0.5 to about 50 weight percent of a second nanoparticle to form an aqueous homogeneous dispersion of nanoparticles and agglomerating agent; and
b) adjusting the pH of the dispersion with mixing to about 3.5 to about 6.5 to agglomerate the nanoparticles.

In another preferred aspect, the first nanoparticle is selected from the group consisting of coated and uncoated colloidal silica.

In another preferred aspect, the second nanoparticle is selected from the group consisting of silica sols, fumed silica, aluminum oxides, iron oxides, zinc oxides, zirconium oxides, tin oxides and cerium oxides.

In another aspect of this invention, a metal oxide coating is applied to the particle agglomerate prepared as described herein. Preferred metal oxides include metal oxides of alumina and ceria. The metal oxide coating provides a cationic surface charge under appropriate pH conditions. The coatings are applied to a targeted coating thickness of 2-5 nm using technology currently employed for coating silica sols. The impact of the coating on agglomerate size is minimal.

In another aspect, this invention is an ink receptive media prepared by applying to a substrate a coating comprising one or more metal oxide particle agglomerates prepared as described herein. Representative substrates include cellulose paper, synthetic paper, non-woven fabrics, plastic films and resin-coated papers. Plastic films include polyester resin (such as polyethylene teraphthalate), polycarbonate resin, fluororesin, polyvinyl chloride resin, and the like. “Resin-coated paper” means papers having a polyolefin resin coating on the surface.

In a preferred aspect of this invention, particle agglomerates used in the ink-receptive coating comprise agglomerated silica particles.

Ink jet applications utilize specialized coating on the printing substrate to improve a multitude of image quality issues. Porous coatings were developed in part to meet escalating print speed demands. The ink receptive coating utilizes capillary action to wick away the mobile phase of an ink jet droplet. Porosity in the coating (internal to the silica particles and due to packing density) allows rapid diffusion of ink into the coating structure while providing capacity for liquid uptake.

To prepare an ink receptive coating the agglomerated silica particles are formulated with a binder such as polyvinyl alcohol (PVA), starch, SBR latex, NBR latex, hydroxycellulose, polyvinyl pyrrolidone, and the like prior to application to a substrate such as paper. The agglomerated silica to binder ratio can be varied but is typically higher in agglomerated silica than binder.

The binder may also be cross-linked to improve the coating strength and reduce cracking. Preferred cross linking agents for PVA binders include boric acid and borates.

The coating is applied to the substrate using a bar coater, a gravure coater, an air knife coater, a blade coater, a curtain coater, and the like and then dried to prepare the ink-receptive coating.

Accordingly, in another aspect, this invention is a method of preparing ink jet printer media comprising applying agglomerated silica particles prepared as described herein to the surface of the paper or other suitable substrate.

In another aspect, this invention is a porous catalyst support comprising one or more particle agglomerates prepared as described herein.

The catalyst support can be for fluidized or fixed bed applications. The support can be prepared by known methods including but not limited to spray drying and extrusion. The support may then be impregnated with catalytic metals such as platinum, palladium, gold, rhodium, or molybendum. Additional metals can be used as required by the specific catalytic process and are obvious to those skilled in the art.

In another aspect, this invention is a filler comprising one or more particle agglomerates prepared as described herein.

Silica has also been used a as a reinforcing filler for elastomeric compositions and injection molded thermoplastics. The silica filler is used to improve the mechanical properties of the basic polymer formulation. In tires, the addition of silica or “white filler” has provided improvements in rolling resistance and traction on snow when compared to convential tires filled with carbon black. Fumed silica and precipitated silica are used as reinforcing filler for rubber compositions. In the application the silica will be treated with a hydrophobizing agent and compounded with the elastomeric composition via mechanical mixing to disperse the silica evenly throughout formulation.

In another aspect, this invention is a flattening agent or gloss modifier comprising one or more particle agglomerates prepared as described herein. Inclusion of particles exceeding 300 nm in coating formulation can result in a reduction in the gloss of the coated surface. These larger particles increase the roughness of the coating. As a result increased scattering of light occurs that reduces the specular gloss of the surface.

In another aspect, this invention is a polishing abrasive comprising one or more particle agglomerates prepared as described herein.

The foregoing may be better understood by reference to the following examples, which are presented for purposes of illustration and are not intended to limit the scope of this invention.

### EXAMPLE 1

### Preparation of an Aluminum Phosphate Reagent

Phosphoric acid (2538 g, of 75%) is placed in a reaction vessel and heated to 90° C. with stirring. Aluminum hydroxide (387 g) is added in small portions to the hot acid solution over 60 minutes. The reaction can be vigorous and may foam. After reaction of substantially all of the aluminum hydroxide (reaction mixture clear) boric acid (78 g) is added in small portions over 30 minutes. The reaction mixture is heated until the solution is clear (about 1 hour after addition of the boric acid). The reaction mixture is then cooled to ambient temperature and deionized water (1650 g) is added to provide a solution of the aluminum phosphate reagent (45% solids).

### EXAMPLE 2

### Preparation of a Silica Particle Agglomerate Using NaOH

Deionized silica sol (30% aqueous dispersion, 416.67 g), deionized water (2083 g) and aluminum phosphate reagent (27.78 g, prepared as in Example 1) are weighed into a reaction vessel. The reaction vessel is stirred at room temperature. The pH of the mixture is 2.17. Aqueous sodium hydroxide solution (1M, 112.5 g) is added over about 15 minutes. The final solution pH is 4.65.

### EXAMPLE 3

### Preparation of Silica Particle Agglomerate Using a pH Buffer

Deionized silica sol (30% aqueous dispersion, 625.0 g), deionized water (1250 g) and aluminum phosphate reagent (41.67 g, prepared as in Example 1) are weighed into a flask and mixed with stirring. A solution of sodium acetate (1 molar, 577.1 g) is weighed into a reaction vessel. The reaction vessel solution is stirred at room temperature. The silica/aluminum phosphate mixture is added to the sodium acetate solution over 45 minutes. The final solution pH is 5.01.

### EXAMPLE 4

### Preparation of a Colloidal Silica/Fumed Silica Composite Agglomerate

CAB-O-SPERSE PG001 (fumed silica, 30% aqueous dispersion, 66.75 g, available from Cabot Corporation, Boston, Mass.) and deionized water (1767.2 g) are mixed. Acetic acid is added for pH adjustment from 10.13 to 3.81. Deionized colloidal silica (25% aqueous dispersion, 716.12 g) and aluminum phosphate reagent (33.58 g, prepared as in Example 1) are added into the reaction mixture with stirring at ambient temperature. The pH of reaction mixture is 2.65. A solution of sodium acetate (1 M, 413.8 g) is weighted into a reaction vessel. The silica/aluminum phosphate mixture is added to the sodium acetate solution with an IKA disperser over 45 minutes. The final solution pH is 4.65. Median particle size for the composite is 311 nm, measured using a Horiba LA-300 particle analyzer.

### EXAMPLE 5

### Preparation of an Aluminum Oxide Coated Silica with Boehmite Composite Agglomerate

Aluminum oxide coated silica sol (27% aqueous dispersion, 355.6 g, Nalco Company, Naperville, Ill.), deionized water (1014 g), boehmite slurry (18.3% aqueous dispersion, 131.15 g), prepared from Sasol 23N4-80 (Sasol North America Inc., Houston, Tex.) and aluminum phosphate reagent (8.64 g, prepared as in Example 1) are weighed into a flask and mixed with stirring. A solution of sodium acetate (1 M, 500 g) is weighed into a reaction vessel. The reaction vessel solution is stirred at ambient temperature. The resulting aluminum oxide coated silica/boehmite/silica/aluminum phosphate mixture is added to the sodium acetate solution equipped with an IKA disperser over 45 minutes. The final solution pH is 4.47 with median particle size for the composite of 374 nm, measured using a Horiba LA-300 particle analyzer.

The agglomerated material prepared as described in Examples 2-5 can be concentrated using ultrafilteration, evaporation, and centrifugation techniques. Typical concentrates comprising about 25 to about 50% solids, depending on particles types and ratios are stable for at least two weeks in a 60° C. oven. This test roughly correlates with minimum 6 months stability at room temperature. The samples will settle with time but can be readily re-dispersed by agitation.

### EXAMPLE 6

### Particle Size Determination

Agglomerated particles size is characterized using a Horiba LA-300 laser scattering particle size distribution analyzer. Table II contains data for typical particle size distribution for a given primary particle size for agglomerated silica particles. Distributions provided are consistent with agglomerates prepared according to the method of Example 2 or Example 3. The particle distribution is calculated using volume basis. The instrument is capable of measuring particles from 100 nm to 600 microns.

TABLE 2
Agglomerate Particle Size Distribution Data

| Primary | | | |
|---|---|---|---|
| Particle | Agglomerate Size | Agglomerate Size | Agglomerate Size |
| (nm) | d₁₀(V) (nm) | d₅₀(V) (nm) | d₉₀(V) (nm) |
| 60 | 162 | 226 | 345 |
| 90 | 215 | 346 | 505 |
| 150 | 326 | 640 | 1083 |

### EXAMPLE 7

### Porosity Determination

Porosity is determined for a standard PVA binder system. Drawdown coatings are prepared using Mellinex 534 (a non-porous polyethylene-terephthate film) as the substrate. The coat weight and coating thickness are determined. A porosity value (percent porosity) is then calculated. The coating porosity data show that an alumina coated silica/boehmite composite material has a porosity about 30% greater than colloidal silica and about 17% greater than agglomerated silica prepared as described above.

TABLE 3
Coating Porosity Values

| Sample | % Porosity |
|---|---|
| Colloidal Silica | 37.5 |
| Agglomerated Silica | 41.0 |
| Colloidal SiO₂/Boehmite Composite | 48.0 |

### EXAMPLE 8

### Preparation of an Ink Receptive Coating Containing Agglomerated Silica Particles

To 500 g of agglomerated silica slurry (50% solids) prepared from 60 nm deionized silica particles according to the method of Example 2 is added with mixing polyvinylalcohol solution (206 g, 30% solids, Celvol 203S, available from Celanese Ltd.). The mixture is stirred for at least one hour.

The particle-binder mixture is then applied on paper to create an ink receptive coating. Hand drawndown coating is applied using a Mayer rod. A coat weight ladder is prepared by varying the Mayer rod used. The coated paper samples are dried and calendared using a Hot Soft Nip calendar. A test pattern is printed on the coated paper and the print characteristics are analyzed. The results are shown in Table 4.

TABLE 4
Data on coated samples

| | Silica/Alumina | |
|---|---|---|
| | Agglomerate | Fumed Silica |
| Pigment:Binder Ratio | 80:20 | 80:20 |
| Black Ink Density | 2.0 | 1.9 |
| Gloss (75 deg) | 70 | 54 |
| Pore Diameter (nm) | 10-30 | 15-70 |
| Solids (%) | 44.6 | 27.6 |
| Viscosity (cps) | 670 | 600 |

As shown in Table 4, good specular gloss and black ink density values are obtained with the agglomerated material. Gloss values are above fumed silica values that is used in commercial inkjet papers. The high ink density values indicate that the ink is retained at the surface and is not wicked into the interior of the coating. Higher coating solids are achieved with the agglomerated material at comparable viscosity. The higher solids will aid processing, dry time, of coated substrates.

Additional experiments demonstrate that high pigment/binder ratios (12:1) are achieved without the presence of dusting while maintaining the high ink density. Dusting is a flaking of the coating that reduces the print quality of the paper and often results in particles that lodge in the paper rolls and jamming the equipment. A high pigment/binder ratio is favorable; a low ratio can impact drying time and limit processing.

Changes can be made in the composition, operation and arrangement of the method of the invention described herein without departing from the concept and scope of the invention as defined in the claims.

1. A method of preparing a metal oxide particle agglomerate comprising
a) adding an aluminum phosphate agglomerating agent with mixing to an aqueous dispersion of one or more metal oxide nanoparticles to form an aqueous homogeneous dispersion of nanoparticles and agglomerating agent; and
b) adjusting the pH of the dispersion with mixing to about 3.5 to about 6.5 to agglomerate the nanoparticles.

2. The method of claim 1 wherein the nanoparticles are selected from the group consisting of silica sols, fumed silica, aluminum oxides, fumed alumina, iron oxides, zinc oxides, zirconium oxides, tin oxides, and cerium oxides.

3. The method of claim 1 wherein the particle agglomerate has a median, d50(V), particle size of about 150 nm to about 900 nm as measured by laser light scattering.

4. The method of claim 1 wherein the pH is adjusted to about 4 to about 6.

5. The method of claim 4 wherein the pH is adjusted using aqueous sodium hydroxide, aqueous potassium hydroxide or aqueous ammonium hydroxide.

6. The method of claim 4 wherein the pH is adjusted by mixing the dispersion of nanoparticles and agglomerating agent with an aqueous pH buffer solution.

7. The method of claim 1 further comprising applying a metal oxide coating to the particle agglomerate.

8. The method of claim 7 wherein the metal oxide coating is selected from oxides of alumina and ceria.

9. The method of claim 2 wherein the nanoparticles are selected from the group consisting of coated and uncoated colloidal silica.

10. The method of claim 9 wherein the coated colloidal silica is selected from the group consisting of aluminum oxide coated silica and cerium oxide coated silica.

11. The method of claim 9 wherein the colloidal silica particles have a particle size of about 3 nm to about 150 nm as measured by quasi elastic light scattering.

12. A method of preparing the particle agglomerate according to claim 1 comprising
a) adding an aluminum phosphate agglomerating agent with mixing to an aqueous dispersion of a mixture of nanoparticles, the mixture comprising about 99.5 to about 50 weight percent of a first nanoparticle and about 0.5 to about 50 weight percent of a second nanoparticle to form an aqueous homogeneous dispersion of nanoparticles and agglomerating agent; and
b) adjusting the pH of the dispersion with mixing to about 3.5 to about 6.5 to agglomerate the nanoparticles.

13. The method of claim 12 wherein the first nanoparticle is selected from the group consisting of coated and uncoated colloidal silica.

14. The method of claim 13 wherein the second nanoparticle is selected from the group consisting of silica sols, fumed silica, aluminum oxides, iron oxides, zinc oxides, zirconium oxides, tin oxides and cerium oxides.

15. A particle agglomerate prepared according to the method of claim 1.

16. An ink-receptive coating for a substrate comprising one or more particle agglomerates prepared according to the method of claim 1.

17. The ink-receptive coating according to claim 16 wherein the particle agglomerates comprise agglomerated silica particles.

18. Paper for use in an ink printing device comprising paper and one or more particle agglomerates prepared according to the method of claim 1 applied to the surface of the paper.

19. A method of preparing ink jet printer paper comprising applying one or more particle agglomerates prepared according to the method of claim 1 to the surface of the paper.

20. A catalyst support comprising one or more particle agglomerates prepared according to the method of claim 1.

21. A reinforcing filler composition comprising one or more particle agglomerates prepared according to the method of claim 1.

22. A flattening agent comprising one or more particle agglomerates prepared according to the method of claim 1.

23. A polishing abrasive comprising one or more particle agglomerates prepared according to claim 1.
